(19) United States
(12) Patent Application Publication
(10) Pub. No.: US 2004/0238797 A1
(43) Pub. Date: Dec. 2, 2004

(54) Powder compositions and methods and apparatus for producing such powder compositions

(75) Inventors: Yasuaki Okada, Aichi-ken (JP); Shigeki Yamada, Aichi-ken (JP)

Correspondence Address: DENNISON, SCHULTZ, DOUGHERTY & MACDONALD, 1727 KING STREET, SUITE 105, ALEXANDRIA, VA, 22314, US

(73) Assignee: Aisan Kogyo Kabushiki Kaisha

(21) Appl. No.: 10/857,936

(22) Filed: Jun. 2, 2004

(30) Foreign Application Priority Data
Jun. 2, 2003 (JP) 2003-156517

(51) Int. Cl. H01C 1/00

(52) U.S. Cl. 252/500

(57) ABSTRACT

A powder composition mainly comprises powder particles having diameters less than 5 μm and further comprises electrically conductive carbon nanomaterial. The addition of the carbon nanomaterial results in lower amounts of agglomeration of the powder particles due to the ability of the carbon nanomaterial to dissipate electric charges generated by electrostatic forces during the formation of a powder composition.

This application claims priority to Japanese patent application serial number 2003-156517, the contents of which are incorporated herein by reference.

### BACKGROUND OF THE INVENTION

1. Field of the Invention

The present invention relates to powder compositions and in particular to powder compositions that mainly comprise a material having low electric conductivity. The present invention also relates to methods and apparatus for producing such powder compositions.

2. Description of the Related Art

Powder compositions are known to be used in various applications. For example, powder compositions are used as product molding materials, membrane forming materials, paint components, and spacers in liquid crystals. Recently it has been contemplated in various fields of applications to form powder particles having very small diameters, on the order of a micron for example, in order to improve the quality of products obtained from the powders. However, as the diameters of the powder particles decrease, there is an increase in the specific surface area of the powder particles and a decrease in the weight of the powder particles. Therefore, the decrease in the diameter of the powder particles may result in an increase in the electrostatic forces and intermolecular forces that may be produced between the powder particles. In particular, when the powder particles are made of materials that have low electrical conductivity or even electrically insulating properties, the powder particles may agglomerate with each other due to the electrostatic forces produced by the frictional contact between the various powder particles. The electrostatic forces also may be produced due to the frictional contact of the powder particles with the wall of a conveying section of an apparatus transporting the powders, so that the powder particles may adhere to the wall. Such agglomeration or adhesion of the powder particles to one another may lower the flowability of the powders and cause difficulties in ensuring a consistent or stable supply of the powders.

In order to improve the flowability of the powders, organic antistatic additives, such as organic surface-active agents, multiple alcohols, e.g., glycerin and sorbit, and fatty-acid ester, have been proposed for use. Such additives are disclosed in Japanese Laid-Open Patent Publication No. 5-330826.

However, the above organic antistatic additives are highly hygroscopic due to their functional groups. Therefore, the organic antistatic additives are not appropriate for use with powders that may tend to be influenced by moisture. In addition, moisture may agglomerate the powders if the organic antistatic additives absorb the moisture.

### SUMMARY OF THE INVENTION

It is accordingly an object of the present invention to teach improved techniques for providing powder compositions that prevent or minimize the accumulation of possible electrostatic charges under various environmental conditions.

According to one aspect of the present teachings, powder compositions are taught including a powder component mainly comprising powder particles having diameters less than 5 μm. The powder compositions further comprise electrically conductive carbon nanomaterial particles mixed with the powder particles.

Therefore, even if the powder particles have developed electrostatic charges due to friction or other reasons, the electrostatic charges may be rapidly transferred and dissipated via the carbon nanomaterial particles. As a result, the powder particles may be prevented or inhibited from the accumulation of electrostatic charges. Consequently, the powder particles may be effectively inhibited from agglomeration or adhesion to the inner walls of a transfer channel. In addition, the carbon nanomaterial does not have a moisture-absorption characteristic and the carbon nanomaterial is stable at various temperatures, under varying levels of moisture content in the surrounding environment, and various pressures. Therefore, the powder particles may be reliably prevented from developing electrostatic charges under various environmental conditions, helping to ensure the flowability of the powder particles.

Preferably, the powder compositions may comprise carbon nanomaterial particles within a range of 0.01 vol % and 5 vol % of the powder composition. Within this range, the carbon nanomaterial particles can effectively inhibit agglomeration and adhesion of powder particles having diameters equal to or less than 5 μm. The range also allows the powder composition to reliably maintain the natural properties of the powder particles.

In another aspect of the present teachings, the carbon nanomaterial particles may have elongated particle configurations having diameters between 1 nm and 50 nm.

In another aspect of the present teachings, the carbon nanomaterial particles may comprise carbon nanotubes, carbon nanohorns, carbon nanofibers or the mixture of any or all of these materials. In order to be electrically conductive, these carbon nanomaterial particles may have a hollow or solid structure with carbon atoms arranged in a sheet-like configuration and may have a length of 1 nm to several nanometers or even a length of several micrometers.

In another aspect of the present teachings, the powder particles comprise tungsten carbide particles or zirconia particles.

In another aspect of the present teachings, the powder composition is used as a material for forming a coating via a spray coating technique. The use of the powder composition containing the carbon nanomaterial particles may result in the coating containing fewer pores or voids and having less overall surface roughness, due to a more uniform distribution of the powder particles within the powder composition.

In another aspect of the present teachings, methods of producing powder compositions are taught. The methods may comprise the steps of (a) producing powder particles, while the produced powder particles are entrained by the flow of a carrier gas, and (b) adding electrically conductive carbon nanomaterial particles to the powder particles, and (c) recovering the powder particles and the carbon nanomaterial particles mixed with the powder particles.

According to these methods, the electrically conductive carbon nanomaterial particles are added to the powder particles prior to the powder particles being recovered. Therefore, the possible accumulation of electrostatic charges in the powder particles due to friction between the powder particles or between the powder particles and another member can be inhibited at an earlier stage through the dissipation of the electrostatic charges via the carbon nanomaterial. Therefore the carbon nanomaterial particles may effectively inhibit the agglomeration and adhesion of the powder particles. In addition, the carbon nanomaterial particles may improve the flowability of the powder composition.

In another aspect of the present teachings, the electrically conductive carbon nanomaterial particles are added to the powder particles while the powder particles are floating in a carrier gas. Therefore, the carbon nanomaterial can be uniformly dispersed among the powder particles that have been produced and the powder particles that are liable to be charged through electrostatic charges. As a result, it is possible to obtain a powder composition with reduced agglomeration of the powder particles due to the uniform dispersal of the electrically conductive carbon nanomaterial particles and the resultant dissipation of electrostatic charges.

In another aspect of the present teachings, evaporating a solid raw material of the powder particles and applying a reactive gas to the evaporated raw material produces the powder particles.

In another aspect of the present teachings, the methods further comprise heating the raw material in order to evaporate the raw material and for accelerating the reaction of the evaporated raw material with the reactive gas. In addition, the methods may farther comprise cooling the powder particles obtained by the reaction of the reactive gas to the raw material. The carbon nanomaterial is added to the cooled powder particles entrained by the carrier gas.

In another aspect of the present teachings, the powder particles are produced by dissolving a volume of a solid raw material of the powder particles into a solvent to obtain a solution of the raw material, producing fine drops or a mist of the solution, and then evaporating the solvent contained within the fine drops.

In another aspect of the present teachings, apparatus are taught that comprise a means for producing a flow of a carrier gas containing powder particles. The apparatus also comprise a means for supplying carbon nanomaterial particles into the flow of the carrier gas, so that the carbon nanomaterial particles are mixed with the powder particles. Additionally, the apparatus includes a means for recovering the mixture of the powder particles and the carbon nanomaterial particles from the carrier gas.

Therefore, it is possible to produce a powder composition in which the carbon nanomaterial particles are uniformly dispersed throughout the powder particles. As a consequence of the more uniform dispersal of the carbon nanomaterial, the powder composition can be produced with a reduced amount of agglomeration.

In another aspect of the present teachings, apparatus are taught that comprise a powder production section for producing powder particles floating in a carrier gas. The apparatus may also include a gas transfer section for transferring the carrier gas containing the powder particles obtained by the powder production section. The transfer section defines a space for the flow of the carrier gas. The apparatus further includes a carbon nanomaterial supply section for supplying carbon nanomaterial into the space of the gas transfer section. The carbon nanomaterial is electrically conductive. The apparatus may further include a powder recovery section disposed at an outlet of the gas transfer section.

In another aspect of the present teachings, apparatus are taught that comprise a reaction tube. A raw material setting region (placement area) is defined within the reaction tube. A reactive gas supply device is connected to the reaction tube and serves to supply a reactive gas into the reaction tube. The reactive gas reacts to the raw material set in the raw material setting region in order to produce powder particles from the raw material. A carrier gas supply device is connected to the reaction tube and serves to supply a carrier gas into the reaction tube. The carrier gas flows through the raw material setting region in order to transfer the powder particles in a predetermined direction. A carbon nanomaterial supply device is connected to the reaction tube and serves to supply carbon nanomaterial particles into the carrier gas containing the powder particles, so that the carbon nanomaterial particles are mixed with the powder particles. A powder recovery device recovers the mixture of the powder particles and the carbon nanomaterial particles.

The apparatus may further comprise a heater for beating the raw material in order to aid in vaporizing the raw material and for accelerating the reaction of the reactive gas to the vaporized raw material. A cooler may cool the carrier gas containing the powder particles. The carbon nanomaterial supply device may preferably be connected to the reaction tube on the downstream side of the cooler.

In another aspect of the present teachings, apparatus for producing a powder composition are taught. The apparatus comprise a reservoir for storing a solution of raw material dissolved into a solvent. An ultrasonic wage generator generates ultrasonic waves that are applied to the solution within the reservoir, producing fine drops or a mist of the solution. A gas supply device serves to supply a mixture of a carrier gas and a reactive gas into the reservoir, so that the mixed gas carries the fine drops of the solution. A reaction tube is connected to the reservoir, so that the mixed gas, carrying the fine drops of the solution, flows into the reaction tube. A heater is mounted to the reaction tube. The solvent within the drops of the solution is evaporated so as to produce particles of the raw material suspended in the mixed gas. The reactive gas reacts to the particles of the raw material, producing powder particles suspended or floating in the carrier gas. A carbon nanomaterial supply device is connected to the reaction tube and serves to supply carbon nanomaterial particles into the carrier gas containing the powder particles. The carbon nanomaterial particles are mixed with the powder particles. A powder recovery device recovers the mixture of the powder particles and the carbon nanomaterial particles.

### BRIEF DESCRPTION OF THE DRAWINGS

FIG. 1 is a schematic view of a first representative apparatus for producing powder compositions; and

FIG. 2 is a sectional view of a second representative apparatus for producing powder compositions.

### DETAILED DESCMMON OF THE INVENTION

Each of the additional features and teachings disclosed above and below may be utilized separately or in conjunction with other features and teachings to provide improved powder compositions and methods and apparatus for producing powder compositions. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

A representative embodiment of the present invention will now be described in connection with representative powder compositions that can be advantageously used as coating materials for painting and thermal spraying. However, the representative powder compositions may be used for any other coating materials, such as vapor deposition materials and solvent spraying materials. In addition, the representative powder compositions may be used for base materials and glaze in the ceramic industries, and powder materials used in the pharmaceutical industries and food industries. In particular, the representative powder compositions suitably include powders made of materials having low electrical conductivity or having electrical insulation properties. Thus, although the representative powder compositions may include metal powders, ceramic powders, plastic powders, rubber powders, elastomer powders, protein powders, sugar powders, etc., the representative powder compositions suitably include ceramic powders, plastic powders, rubber powders, elastomer powders and the like, that have low electrical conductivity. The representative powder compositions may also include metal oxide powders, metallic carbide powders, and metallic nitride powders, etc. For example, the representative powder compositions may include tungsten carbide (WC) powders and zirconia (ZrO₂) powders.

The representative powder composition includes a main powder component with particles each having a diameter equal to or less than 5 μm. The representative powder composition further includes a secondary powder component made of electrically conductive carbon nanomaterial. The main powder component may be made of a single kind of material or may be made of plural kinds of material. However, in addition to the main powder component, the powder composition may include other powder components including particles having some diameters greater than 5 μm. In other words, the powder composition may include another powder component having an average diameter equal to or less than 5 μm or a mixture of other powder components, in which the mixture has an average diameter equal to or less than 5 μm.

In general, the diameter of 5 μm is a critical diameter for powder particles. The influence of the electrostatic force, the intermolecular force, the liquid cross-linking force, etc., to the flowability of the powder particles may increase as the diameter decreases from 5 μm. If the diameter increases from 5 μm, the influence of these forces may decrease due to the increase in the gravity forces applied to the powder particles. If the diameter is less than 5 μm, the specific surface area of a powder particle may increase. In particular, if the particles are made of an insulative material or a material having low electrical conductivity, the electrostatic force may increase in influence. There is no particular lower limit to the particle diameter of the main powder component. The main powder component may include particles having different diameters and having various diameter distributions as long as such particles can be manufactured with diameters equal to or less than 5 μm.

In addition, there is no particular limitation to the structure and construction of particles of the main powder component. For example, each particle may be made of a single material or may be made of a mixture of plural kinds of material. In addition, each particle may have a composite structure including at least one coating layer. Further, each particle may be a crystal or may be a granule containing voids. Furthermore, each particle may have any desired shape, such as a spherical shape, a tubular shape, a cylindrical shape or a disk shape.

In general, the carbon nanomaterial has a plurality of carbon atoms arranged in a sheet-like configuration and has a tubular structure with a length of 1 nm to several hundred nanometers or even with a length of several micrometers. The carbon nanomaterials may have various kinds of configurations. For example, the carbon nanomaterial may be configured as single layer carbon nanotubes each having a single layer tubular configuration or the carbon nanomaterial may be configured as multilayer carbon nanotubes each having a multilayer tubular configuration. In addition, carbon nanohorns and carbon nanofibers may be used. The carbon nanohorn may have a tubular structure with one end closed by a carbon sheet structure. The carbon nanofiber may comprise serially connected units each constituted by carbon atoms and having a tubular configuration or a conical configuration having open opposite ends. In particular, carbon nanotubes and carbon nanohorns having high amounts of electrical conductivity may be advantageously used as the carbon nanomaterial of this representative embodiment. In addition, the carbon nanomaterial may include a single kind of configuration or may include plural kinds of configurations.

There is no particular limitation to the particle size of the carbon nanomaterial used in this representative embodiment. However, if carbon nanotubes, carbon nanohorns, or carbon nanofibers having elongated configurations are used, they may preferably have a diameter between 1 nm and 50 nm. In addition, they may have various lengths, such as on the order of nanometers and the order of micrometers. They may even have a length of less than 1 nm or greater than 50 nm if they exhibit high amounts of electrical conductivity. For example, carbon nanotubes having a diameter of 0.5 nm and a carbon nanofibers having a diameter of 100 nm may be used. The size and configuration of particles of the carbon nanomaterial may be selected in consideration of the application of the powder composition, the desired particle range of the powder composition, and ease of mixing the carbon nanomaterial. For example, the powder composition used for spray coating may preferably contain carbon nanomaterial particles having a particle diameter of about 1 nm so that a coated layer may be formed having a uniform thickness and a smooth surface.

Also, there is no particular limitation to the percentage of the carbon nanomaterial supplied to the powder composition. However, the carbon nanomaterial may preferably be contained within a range of 0.01 vol % to 5 vol %. Within this range, the possible electrostatic charges generated in the powder composition can be effectively removed or dissipated by the carbon nanomaterial. Therefore, potential agglomeration of the powder composition or the possible adhesion of the powder composition onto an inner wall of a pipeline, etc., due to the buildup of electrostatic charges can be inhibited. Also, non-uniform distribution of the electric charges (polarities) may possibly be reduced. If the percentage of the carbon nanomaterial is less than 0.01 vol %, the carbon nanomaterial may not effectively inhibit the reduction of flowability of the powder composition. On the other hand, if the percentage of the carbon nanomaterial is greater than 5 vol %, a possibility may exist that the carbon nanomaterial will exert unwanted influence on the intended or desired main characteristics of the powder composition.

Due to the electrical conductivity of the carbon nanomaterial, the powder composition may be effectively prevented from developing a charge. Therefore, possible agglomeration of the main powder components or possible adhesion onto an inner wall of a transfer pipeline or a nozzle can be effectively reduced, even if the powder composition includes main powder components that have particle diameters equal to or less than 5 μm. Therefore, the representative powder composition can reliably maintain flow ability. In particular, the carbon nanomaterial typically has no substantial tendency to absorb moisture and the carbon nanomaterial has good stability resisting heat in comparison with an organic material. These factors allow the carbon nanomaterial to effectively remove or neutralize the electrostatic charges under various conditions. Consequently, the powder composition can effectively maintain flow ability under various conditions. In addition, if desired the carbon nanomaterial may be burned in order to removed it from the powder composition. Because only carbon atoms make up the carbon nanomaterial, no harmful substance may be produce, Therefore, the carbon nanomaterial can be safely removed from the powder composition.

Representative methods for producing the powder composition will now be described. The powder component of the powder composition may be produced by various known methods. For example, utilizing a grinding method or a chemical growing method may produce the powder component. Because, the main powder component comprises particles having diameters equal to or loss than 5 μm a chemical growing method may preferably be used to produce the powder component. In general, the chemical growing method comprises a gaseous phase method and a liquid phase method, either of which may be used for producing the powder component. The gaseous phase method may further include an evaporating and condensing method (known as a PVD method) and a gaseous phase reaction method (known as a CVD method). The liquid phase method may further include a solvent evaporating method and a precipitation method.

Other various known methods may also produce the carbon nanomaterial, such as an arc-discharge method and a chemical deposition method (known as a CVD method). Commercially available carbon nanomaterials can be used as is or after they are suitably refined or screened.

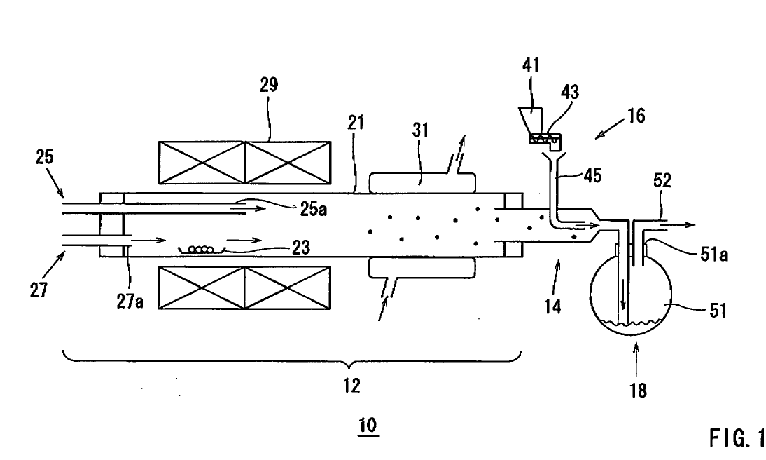

Referring to FIG. 1, there is shown a first representative apparatus 10 for producing the powder composition by a first representative method. The first representative apparatus 10 generally comprises a powder production section 12, a gas communication section 14, a carbon nanomaterial supply section 16, and a powder recovery section 18. The powder production section 12 is configured to produce the powder component by utilizing the CVD method, specifically an electric furnace method in the CVD method. The gas communication section 14 serves to transfer a gas containing the powder component.

As shown in FIG. 1, the powder production section 12 mainly comprises a reaction tube 21 that is sealingly separated from the outside environment. A carrier gas supply device 27 and a reactive gas supply device 25 respectively include a nozzle 27a and a nozzle 25a, which extend into one end of the reaction tube 21 so as to communicate with the interior of the reaction tube 21. The carrier gas supply device 27 and the reactive gas supply device 25 further include their respective gas supply means, such as pumps and storage tanks for example. The carrier gas supply device 27 serves to supply a carrier gas into the reaction tube 21 at a predetermined flow rate. A raw material setting region 23 is located within the reaction tube 21 at a position adjacent to one end (right end as viewed in FIG. 1) of the nozzle 27a of the carrier gas supply device 27. The raw material setting region 23 is configured as a shallow tray or holder, in which a solid raw material for the powder component is placed.

The reactive gas supply device 25 serves to supply a reactive gas at a predetermined flow rate. The reactive gas reacts with the raw material set in the raw material setting region 23. One end (right end as viewed in FIG. 1) of the nozzle 25a of the reactive gas extends beyond (to the right as viewed in FIG. 1) the raw material setting region 23.

A heater 29 and a cooler 31 are disposed around the outer periphery of the reaction tube 21. The heater 29 serves to heat the raw material in order to accelerate the vaporization of the raw material and to cause reaction by the reactive gas with the vaporized raw material. The heater 29 extends along the outer periphery of the reaction tube 21 from a position on the rear side (left side as viewed in FIG. 1) of the raw material setting region 23 to a position on the front side (right side as viewed in FIG. 1) of the one end of the nozzle 25a of the reactive gas supply device 25. The cooler 31 serves to cool a powder-containing gas produced as a result of the previous reaction. In this representative embodiment, the cooler 31 has a tubular configuration around the outer periphery of the reaction tube 21 so as to cover a portion of the reaction tube on the front side of the heater 29. The cooler 31 may define an inner space within which a refrigerant may circulate as in known coolers.

The gas communication section 14 is configured as a tube that communicates with the front end of the reaction tube 21. The gas communication section 14 serves to transfer the gas produced by the previous reaction to the powder recovering section 18.

The carbon nanomaterial supply section 16 comprises a hopper 41, a screw conveyer 43, and a supply pipe 45. The carbon nanomaterial may be prepared in advance. The carbon nanomaterial may be continuously transported at a predetermined rate by the hopper 41 and the screw conveyer 43. The transported carbon nanomaterial is then supplied into the supply pipe 45 via an open upper end of the supply pipe 45 disposed below the screw conveyer 43. A lower portion of the supply pipe 45 extends into the gas communication section 14 and is bent in the flowing direction of the produced gas, so that the lower end is opened in the flowing direction of the produced gas.

The gas recovery section 18 comprises storage 51 and a gas discharge pipe 52. The storage 51 serves to receive and store the powder component contained in the produced gas. In this representative embodiment, the storage 51 has a substantially spherical configuration with an opening 51a located in an upper portion. The front portion of the gas communication section 14 opens into the storage 51 via an inlet in opening 51a. The gas discharge pipe 52 extends from inside of the storage 51 to the outside via an outlet in opening 51a.

The first representative method will now be described with reference to FIG. 1.

(Powder Production Process)

The powder component may be produced so as to have a desired property from a known raw material. For example, if a powder component made of nickel (Ni) is to be produced, nickel chloride (NiCl₂) is used as a raw material and is set or placed in the raw material setting region 23. In such a case, hydrogen (H₂) gas is supplied from the reactive gas supply section 25 as the reactive gas. If a powder component made of tungsten carbide (WC) is to be produced, tungsten chloride (WCl₆) is set in the raw material setting region 23 and a mixture of hydrogen (H₂) gas and methane (CH₄) gas is supplied from the reactive gas supply section 25.

The heater 29 therefore heats the reaction tube 21 at a predetermined set temperature, while a carrier gas (e.g., inert gas) is supplied into the reaction tube 21 via the carrier gas supply device 27. As a result, the solid raw material is vaporized and is fed forwardly (rightward as viewed in FIG. 1). The heater 29 further heats the vaporized raw material as the vaporized raw material is fed forwardly. After the vaporized raw material has been sufficiently heated, the vaporized raw material is mixed with the reactive gas supplied from the reactive gas supply device 25 at a predetermined flow rate. Therefore, the vaporized raw material rapidly and chemically reacts to the reactive gas to produce fine powder particles.

(Carbon Nanomaterial Charging Process)

To obtain particles within a desired diameter range the cooler 31 cools the produced powder particles so that undesirable secondary reactions and excessive enlargement can be inhibited. The powder particles then flow forward (rightward as viewed in FIG. 1) together with the carrier gas and the reactive gas to enter the gas communication section 14.

The carbon nanomaterial may be supplied from the carbon nanomaterial supply section 16 into the gas communication section 14 at such a flow rate that the carbon nanomaterial is mixed with the powder particles at a predetermined volume percentage. To this end, a volume of the carbon nanomaterial is placed into the hopper 41 of the carbon nanomaterial supply section 16. The volume of carbon nanomaterial is then dispersed into the gas communication section 14 at a predetermined volumetric flow rate via the screw conveyer 43 and the supply pipe 45.

(Powder Recovery Process)

After flowing through the gas communication section 14, the gas containing the powder particles and the carbon nanomaterial is transferred from the gas communication section 14 to the storage 51 component of the powder recovering section 18. As shown in FIG. 1, the cross sectional area of the gas communication section 14 becomes smaller in area toward the storage 51. The powder particles frictionally contact with the inner walls of the gas communication section 14 or the powder particles frictionally contact with each other, potentially causing the powder particles to be electrostatically charged. However, such electrostatic charge may be rapidly dissipated via the carbon nanomaterial. The powder particles and the carbon nanomaterial may be recovered through precipitation or deposition within the storage 51. The gas, after the recovery of the powder particles and the carbon nanomaterial, may be discharged to the outside environment via the gas discharge pipe 52. The electrostatic charge generated within storage 51, by the frictional contact between the powder particles and the inner wall of the storage 51 or by the frictional contact between the various powder particles, also may be rapidly dissipated via the carbon nanomaterial.

According to the first representative method, the powder particles are produced in the state of floating in the gas. The carbon nanomaterial is then supplied into the gas. Therefore, the carbon nanomaterial can be added to the powder particles before the powder particles fictionally contact with either each other or the inner wall of the supply pipe 21. After the addition of the carbon nanomaterial, any electrostatic charges generated or stored in the powder particles may be rapidly dissipated via the carbon nanomaterial. Therefore, the powder composition may be produced without causing agglomeration, adhesion onto the inner wall of the gas communication section 14, and clogging within the gas communication section 14 of the powder particles. In particular, because the agglomeration of the powder particles can be inhibited at an early stage of production, the powder composition may be produced so as to have a high degree of dispersibility even though the powder composition includes powder particles having diameters equal to or less than 5 μm. In addition, because the powder composition obtained according to the first representative method is inhibited from developing a static electricity charge by the carbon nanomaterial, the powder composition is able to maintain good flowability. Furthermore, the operability of the overall powder composition production system can be improved because the carbon nanomaterials used in this first representative method are handled as particles that are directly supplied into the gas containing the powder particles, thereby being mixed with the powder particles.

Furthermore, a known powder production apparatus can be easily converted into the representative apparatus 10 by adding the carbon nanomaterial supply section 16 to a gas communication channel of a known apparatus. Thus, it is not necessary to incorporate a separate or additional mixing device for mixing the powder particles together with the carbon nanomaterial and it is possible to inhibit the accumulation of electrostatic charges within the powder particles at an early stage of production of the powder, particles. This allows the powder particles to be efficiently produced.

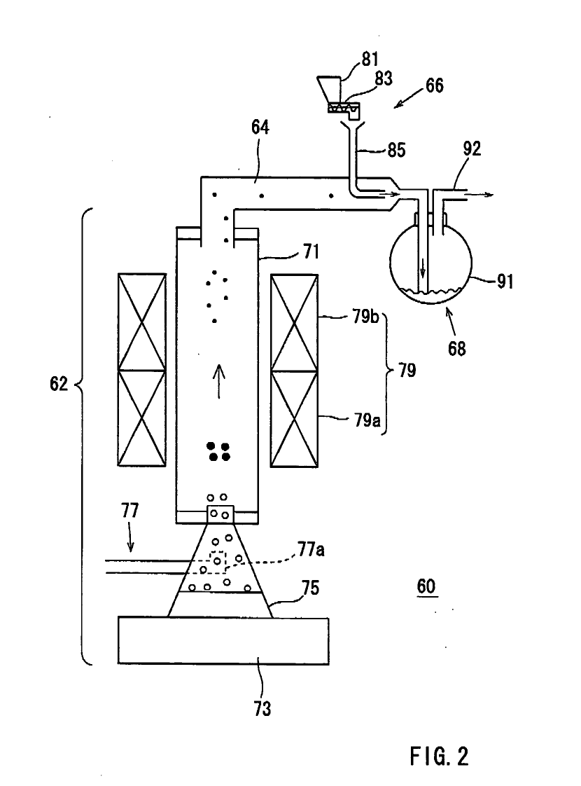

A second representative apparatus 60 for producing the powder composition will now be described with reference to FIG. 2. The second representative apparatus 60 generally comprises a powder production section 62, a gas communication section 64, a carbon nanomaterial supply section 66 and a powder recovery section 68. The powder production section 60 serves to produce powder particles by a liquid phase method, in particular, by a solvent evaporation method. The gas communication section 64 serves to transfer a gas containing the powder particles.

The powder production section 62 comprises an ultrasonic wave generator 73, a reservoir 75 for storing a solution containing the raw material, a gas supply device 77, a reaction tube 71, and a heater 79. The ultrasonic wave generator 73 generates ultrasonic waves that are applied to the solution stored within the reservoir 75, causing the solution to be vaporized. The solution stored within the reservoir 75 contains a metal salt that is the raw material of the powder particles. The reservoir 75 has an open upper end.

The gas supply device 77 has a nozzle 77a that extends into the upper portion of the reservoir 75. The nozzle 77a is oriented to provide a flow of a gas at a predetermined flow rate in a direction vertically upward as viewed in FIG. 2. The gas may contain a carrier gas and a suitable reactive gas. The lower portion of the reaction tube 71 is configured to enclose the upper portion of the reservoir 75. The reaction tube 71 extends vertically upward from the reservoir 75. The upper end of the reaction tube 71 is connected to the gas communication section 64. The heater 79 has a tubular configuration to enclose the outer periphery of the middle portion of the reaction tube 71. In this representative embodiment, the heater 79 comprises a first heater 79a and a second heater 79b, disposed upward or downstream of the first heater 79a. The first heater 79a is used for drying and the second heater 79b is used for initiating and/or accelerating the reaction.

The gas communication section 64 is configured as a tube connected to the upper end of the reaction tube 71. The gas communication section 64 also defines an inner space through which the gas flows. The downstream opening of the gas communication section 64 is connected to the powder recovering section 68.

The carbon nanomaterial supply section 66 serves to supply the carbon nanomaterial to the gas communication section 64 and comprises a hopper 81, a screw conveyor 83, and a supply pipe 85. The hopper 81, the screw conveyor 83, and the supply pipe 85, are respectively the same as the hopper 41, the screw conveyor 43, and the supply pipe 45, of the carbon nanomaterial supply section 16 previously described in the first representative apparatus 10. Therefore, the explanations for these elements will not be repeated.

A second representative process for producing a powder composition by using the above second representative apparatus 60 will now be described. First, a solution containing a desired raw material is prepared and placed into the reservoir 75. The solution can be prepared in a known manner. If powder particles of titanium oxide are to be produced, a volume of titanium oxide is dissolved into ammonia water, so that a gel-like solution of titanium oxide is obtained. The final solution is obtained by using nitric acid to deflocculate the gel-like solution. If powder particles of Mg_{0.5}Mn_{0.5}Fe₂O₄ that comprise metal oxide are to be produced, a volume of magnesium nitrate, manganese nitrate, and iron nitrate (III), are dissolved into ethanol in order to obtain the solution.

The solution prepared in these ways is set into the reservoir 75. Ultrasonic waves, generated by the ultrasonic wave generator 73, are applied to the solution so that fine liquid drops or a mist of the solution is produced. If appropriate, the solution may be heated to facilitate the production of the fine liquid drops. The carrier gas (including the reactive gas) is supplied from the gas supply device 77 into the reservoir 75 at a predetermined flow rate so that the carrier gas containing the liquid drops of the solution of the raw material is fed into the reaction tube 71.

In the same manner as in the first representative embodiment, the heater 79 heats the gas supplied into the reaction tube 71. More specifically, the first heater 79a mainly serves to dry the gas and evaporate the solvent. The second heater 79b primarily serves to cause a thermal decomposition reaction to produce the expected powder particles. The gas containing the powder particles may flow upward within the reaction tube 71 and enter the gas communication section 64.

Also in the same manner as in the first representative embodiment, a volume of the carbon nanomaterial is supplied into the gas communication section 64 by the carbon nanomaterial supply section 66. The carbon nanomaterial is supplied in the same direction as the flow of the gas within the gas communication section 64 in order for the carbon nanomaterial to be mixed with the powder particles. Thereafter, the gas containing the mixture of the powder particles and carbon nanomaterial is transferred to the powder recovery section 68. The powder particles and the carbon nanomaterials are recovered and stored within the storage 91 while the gas is discharged from the gas discharge pipe 92.

Also with the second representative apparatus 60, the carbon nanomaterial is mixed with the powder particles that are floating or suspended in the gas prior to the powder particles being recovered in an accumulated state. Therefore, it is possible to inhibit the agglomeration of the powder particles and to provide a high degree of dispersibility of the powder composition.

The present invention may not be limited to the above representative embodiments but may be modified in various ways. For example, the carbon nanomaterial supply section may be positioned at any location within a gas transfer region. In the first representative embodiment, a gas transfer section may be defined between a part of the reaction tube 21 corresponding to substantially the middle of the heater 29 and the front (right as viewed in FIG. 1) end of the gas communication section 14. In the second representative embodiment, a gas transfer section may be defined between a part of the reaction tube 71 at the upper end of the heater 79 and the downstream side end of the gas communication section 64.

Therefore, in one alternative arrangement of the first representative embodiment, the carbon nanomaterial supply section 16 may be disposed at the same position of the cooler 31 or a position adjacent to the cooler 31, so that the carbon nanomaterial may be supplied at the same time as the cooling process. In one alternative arrangement of the second representative embodiment, the carbon nanomaterial supply section 66 may be disposed at a portion of the reaction tube 71 between the heater 79 and the upper end of the reaction tube 71.

In addition, the carbon nanomaterial supply section 16(66) may have various configurations including known devices for supplying particulate materials. For example, the carbon nanomaterial supply section may include a hopper, a belt-conveyer, a sieve, a supply pipe, and a control valve that is controlled so as to open and close by a control device.

Further, it is preferable that the carbon nanomaterial is added to and mixed with the powder particles at the earliest time possible, as long as the production of the powder particles is not interfered or hindered. Therefore, if the reaction for producing the powder particles is not significantly hindered by the presence of the carbon nanomaterial, the carbon nanomaterial may be supplied into the reaction tube together with the carrier gas and the reactive gas. In this type of situation, the carbon nanomaterial is mixed with the powder particles at the same time that the powder particles are produced.

### EXAMPLES OF PRODUCTION OF POWDER COMPOSITIONS

### Example 1

A volume of tungsten chloride (WCl₆) was set in the raw material setting region 23 of the first representative apparatus 10. A mixture of a hydrogen (H₂) gas and a methane (CH₄) gas was then supplied from the reactive gas supply device 25 at a predetermined flow rate. In addition, a nitrogen gas was supplied from the carrier gas supply device 27 at a predetermined flow rate. The heater 29 heated the reactive tube 21 until the reaction region within the reactive tube 21 reached a temperature of 1,100° C. This resulted in the tungsten chloride reacting to the mixed gas to produce powder particles of tungsten carbide (WC) having an average diameter of 3 μm. Additionally, carbon nanotube powder having a particle diameter of 1 nm was continuously supplied from the carbon nanomaterial supply section 16 to the WC powder particles at such a volumetric flow rate that the carbon nanotube powder represented 0.05 vol % of the powder composition. The resulted gas was dried and recovered at the powder recovering section 18 in order to obtain a powder composition. This powder composition produced in this way will be hereinafter referred to as “powder composition example 1,” obtained according to the first representative embodiment.

### Example 2

According to substantially the same process as the process for producing the powder composition example 1, WC powder particles were produced having an average particle diameter of 4 μm, while the flow rate of the mixture of the hydrogen gas and the methane, the mixing ratio of these gases, the flow rate of the nitrogen gas, the temperature of the reaction region within the reaction tube, etc. were all appropriately set. The same type of carbon nanotube powder as used in powder composition example 1 was then supplied from the carbon nanomaterial supply section 16 to the WC powder particles at such a volumetric flow rate that the carbon nanotube powder was 5 vol % of the powder composition. The resulting gas was dried and recovered in the same manner as powder composition example 1. The powder composition thus produced will be hereinafter referred to as “powder composition example 2.”

### Example 3

In much the same manner as in powder composition example 2, WC powder particles were produced having an average particle diameter of 4 μm. Carbon nanotube powder having a particle diameter of 40 nm was supplied from the carbon nanomaterial supply section 16 to the WC powder particles at such a volumetric flow rate that the carbon nanotube powder was 5 vol % of the powder composition. The resulted gas was dried and recovered in the same manner as the first and second powder composition examples 1 and 2. The powder composition thus produced will be hereinafter referred to as “powder composition example 3.”

### Comparative Example 1

WC powder particles were produced having an average particle diameter of 3 μm according to substantially the same process as the process used in producing the powder composition example 1. The WC powder particles were then dried and recovered without the addition of the carbon nanotube powder. The powder composition thus produced will be hereinafter referred to as “comparative powder composition 1.”

### Comparative Example 2

WC powder particles were produced having an average particle diameter of 4 μm according to substantially the same process as the process used for producing the powder composition example 2. The same type of carbon nanotube powder that was used for powder composition example 1 was supplied to the WC powder particles at such a volumetric flow rate that the carbon nanotube powder was 20 vol % of the powder composition. The resulting gas was dried and recovered in the same manner as in the first and second powder composition examples 1 and 2, producing “comparative powder composition 2.”

The average diameters of the WC powder particles, the diameters of the carbon nanomaterials, and the volume percentages of the carbon nanomaterials content of the powder compositions examples 1 to 3 and the comparative powder compositions 1 and 2 are listed in the following Table 1.

TABLE 1

| | TUNGSTEN | CARBON | |
|---|---|---|---|
| | CARBIDE | NANOMATERIAL | |
| | PARTICLE | DIAMETER | CONTENT |
| | DIAMETER (μm) | (nm) | (VOL %) |
| EXAMPLE 1 | 3 | 1 | 0.05 |
| EXAMPLE 2 | 4 | 1 | 5 |
| EXAMPLE 3 | 4 | 40 | 5 |
| COMPARATIVE | 3 | 1 | 0 |
| COMPOSIITON 1 | | | |
| COMPARATIVE | 4 | 1 | 20 |
| COMPOSITION 2 | | | |

(Formation of Sprayed Coating)

The powder composition examples 1 to 3 and the comparative powder compositions 1 and 2 were applied onto substrates made of carburised and quenched steel (SCM415 regulated by Japanese Industrial Standard (JIS)) at a rate of 5 g/min by a high-speed flame spraying technique utilizing a spraying device (Model No. JP-5000 manufactured by TAFA Corporation), forming coatings on the substrates.

The existence of the agglomeration of powder particles on a surface of each coating was determined through observation by a scanning electron microscope and through analysis by an energy dispersive X-ray analyzer. In addition, the porosity in cross section and the surface roughness were measured for each coating. Here, the porosity is a percentage of pore areas in an image of a cross section of the coating observed by the scanning electron microscope. A roughness gauge of a type having a sensing pin measured the roughness of the coating surface. In addition, visual inspection was performed in an attempt to observe possible adhesion of each powder composition onto an inner wall of a powder transfer channel, through which the powder composition is supplied prior to spraying. The results of the observation and measurement are shown in the following Table 2.

TABLE 2

| | | PERFORMANCE OF COATINGS | | |
|---|---|---|---|---|
| | ADHESION OF POWDER | | | SURFACE |
| | PARTICLES ONTO WALL | AGGLOMERATION | POROSITY | ROUGHNESS |
| | OF TRANSFER CHANNEL | OF PARTICLES | (%) | (μm) |
| EXAMPLE 1 | none | none | 1 | 20 |
| EXAMPLE 2 | none | none | 2 | 23 |
| EXAMPLE 3 | none | none | 3 | 25 |
| COMPARATIVE | observed | observed | 5 | 55 |
| COMPOSITION 1 | | | | |
| COMPARATIVE | none | none | 25 | 65 |
| COMPOSITION 2 | | | | |

The results of Table 2 indicated that no agglomeration and no adhesion of powder particles has been detected for the powder composition examples 1 to 3 and the comparative powder composition 2 containing carbon nanotubes. In contrast, the comparative powder composition 1, containing the same WC powder particles as the powder composition example 1, resulted in both adhesion and agglomeration Therefore, it has been shown that possible electrostatic charging of the powder composition can be effectively inhibited or reduced by the inclusion of the carbon nanotube powder.

The results of Table 2 also indicated that the porosity and the surface roughness of the sprayed coatings produced by the powder composition examples 1 to 3 (containing the carbon nanotube powder between 0.05 vol % and 5 vol %) are less than those of the sprayed coatings produced by the comparative powder composition I not containing any carbon nanotube powder. In particular, the surface roughness of the sprayed coatings produced by the powder composition examples 1 to 3 is less than 25 μm, i.e., less than half the surface roughness of the coating of the comparative powder composition 1. Therefore, the coating surfaces of the powder composition examples were improved in terms of smoothness due in part to the addition of the carbon nanotube powder. Because the powder composition examples 1 to 3 have shown substantially no agglomeration and no substantial adhesion, this indicates that the WC powder particles might have been effectively dispersed so as to produce uniform coatings. The porosity and the surface roughness of the coating of the comparative powder composition 2, containing a 20 vol % of carbon nanotube powder having a diameter of 1 nm, arc larger than those of the coating formed from the comparative powder composition 1. This indicates that the percentage of carbon nanotube powder may be excessive in the comparative powder composition 2. Thus, as the content of the carbon nanomaterial increases, portions without WC powder particles may be produced due to the increased presence of the carbon nanomaterial causing the coating may become non-uniform. However, when comparing the powder composition example 2 to the powder composition example 3, both composition examples containing carbon nanotubes in the same percentage content but using differently sized diameters of carbon nanotubes, the powder composition example 3 containing the carbon nanotubes having a larger diameter resulted in a lower porosity and lower surface roughness than powder composition example 2.

This invention claims:

1. A powder composition comprising:
a powder component mainly comprising powder particles having diameters equal to or less than 5 μm; and
electrically conductive carbon nanomaterial particles;
wherein the carbon nanomaterial particles are mixed with the powder component.

2. The powder composition as in claim 1, wherein the carbon nanomaterial particles are contained in a range of 0.01 vol % and 5 vol % of the powder composition.

3. The powder composition as in claim 1, wherein the carbon nanomaterial particles comprise elongated particle configurations having diameters contained in a range of 1 nm and 50 nm.

4. The powder composition as in claim 3, wherein the carbon nanomaterial particles are selected from a group consisting of carbon nanotubes, carbon nanohorns, and carbon nanofibers.

5. The powder composition as in claim 1, wherein the powder particles comprise tungsten carbide particles.

6. The powder composition as in claim 1, wherein the powder particles comprise zirconia particles.

7. A spray coating material comprising:
a powder component mainly comprising powder particles having diameters equal to or less than 5 μm; and
electrically conductive carbon nanomaterial particles;
wherein the carbon nanomaterials are mixed with the powder component.

8. The spray coating material as in claim 7, wherein the carbon nanomaterial particles are contained in a range of 0.01 vol % and 5 vol % of the spray coating material.

9. The spray coating material as in claim 8, wherein the powder particles comprise tungsten carbide particles and the carbon nanomaterial particles comprise carbon nanotubes.

10. A method of producing a powder composition, comprising:
(a) forming powder particles while the produced powder particles are suspended in a flow of a carrier gas, and
(b) mixing electrically conductive carbon nanomaterial particles with the powder particles, and
(c) recovering the powder particles and the carbon nanomaterial particles mixed with the powder particles.

11. The method as in claim 10, wherein the step (b) further comprising mixing the electrically conductive carbon nanomaterial particles with the powder particles while the powder particles are suspended in the carrier gas.

12. The method as in claim 10, wherein the forming of the powder particles further comprises the steps of;
evaporating a solid raw material of the powder particles; and
applying a reactive gas to the evaporated raw material to produce the powder particles.

13. The method as in claim 12, further comprising the step of;
heating the solid raw material to facilitate the evaporation the raw material and for accelerating the reaction of the evaporated raw material with the reactive gas.

14. The method as in claim 13, further comprising the step of;
cooling the powder particles obtained by the reaction of the reactive gas with the raw material;
wherein the carbon nanomaterial is added to the cooled powder particles suspended in the carrier gas.

15. The method as in claim 10, wherein the forming of the powder particles further comprises the steps of;
dissolving a volume of solid raw material of the powder particles into a solvent so as to obtain a solution of the raw material;
producing fine drops of the solution; and
evaporating the solvent contained in the drops.

16. The method as in claim 10, wherein the step (c) further comprises;
separating the carrier gas and reactive gas from the mixture of the powder particles and the carbon nanomaterial particles.

17. An apparatus comprising:
means for producing a flow of a carrier gas containing powder particles; and
means for supplying electrically conductive carbon nanomaterial particles into the flow of the carrier gas, so that the carbon nanomaterial particles are mixed with the powder particles; and
means for recovering the mixture of the powder particles and the carbon nanomaterial particles from the carrier gas.

18. An apparatus for producing a powder composition, comprising:
a powder production section arranged and constructed to produce powder particles suspended in a carrier gas; and
a gas transfer section arranged and constructed to transfer the carrier gas containing the powder particles obtained by the powder production section, wherein the transfer section defines a space for the flow of the carrier gas; and
a carbon nanomaterial supply section arranged and constructed to supply carbon nanomaterial into the space of the gas transfer section, wherein the carbon nanomaterial is electrically conductive; and
a powder recovery section disposed at an outlet of the gas transfer section.

19. An apparatus for producing a powder composition comprising:
a reaction tube; and
a raw material setting region defined within the reaction tube, and
a reactive gas supply device connected to the reaction tube and arranged and constructed to supply a reactive gas into the reaction tube, wherein the reactive gas reacts to a raw material set in the raw material setting region in order to produce powder particles from the raw material; and
a carrier gas supply device connected to the reaction tube and arranged and constructed to supply a carrier gas into the reaction tube, wherein the carrier gas flows through the raw material setting region in order to transfer the powder particles in a predetermined direction;
a carbon nanomaterial supply device connected to the reaction tube and arranged and constructed to supply carbon nanomaterial particles into the carrier gas containing the powder particles, so that the carbon nanomaterial particles are mixed with the powder particles,
a powder recovery device arranged and constructed to recover the mixture of the powder particles and the carbon nanomaterial particles.

20. The apparatus as in claim 19, further comprising;
a heater arranged and constructed to heat the raw material in order to vaporize the raw material and for accelerating the reaction of the reactive gas with the vaporized raw material, and
a cooler arranged and constructed to cool the carrier gas containing the powder particles.

21. The apparatus as in claim 20, wherein the carbon nanomaterial supply device is connected to the reaction tube downstream of the cooler.

22. An apparatus for producing a powder composition comprising:
a reservoir arranged and constructed to store a solution of a raw material dissolved into a solvent;
a ultrasonic wage generator arranged and constructed to generate ultrasonic waves applied to the solution within the reservoir, so that fine drops of the solution are produced,
a gas supply device arranged and constructed to supply a mixture of a carrier gas and a reactive gas into the reservoir, so that the drops of the solution are carried by the mixed gas;
a reaction tube connected to the reservoir, so that the drops of the solution carried by the mixed gas flows into the reaction tube,
a heater mounted to the reaction tube, so that the solvent of the drops of the solution are evaporated to produce particles of the raw material floating in the mixed gas, and the reactive gas reacts to the particles of the raw material to produce powder particles floating in the carrier gas,
a carbon nanomaterial supply device connected to the reaction tube and arranged and constructed to supply carbon nanomaterial particles into the carrier gas containing the powder particles, so that the carbon nanomaterial particles are mixed with the powder particles,
a powder recovery device arranged and constructed to recover the mixture of the powder particles and the carbon nanomaterial particles.
